(19) United States
(12) Patent Application Publication
(10) Pub. No.: US 2019/0366765 A1
(43) Pub. Date: Dec. 5, 2019

(54) WHEEL RIM

(71) Applicant: CHING-FU CHUANG, Taipei City (TW)

(72) Inventor: CHING-FU CHUANG, Taipei City (TW)

(21) Appl. No.: 15/991,180

(22) Filed: May 29, 2018

(51) Int. Cl. B60B 25/20; B60C 25/01

(52) U.S. Cl. CPC B60B 25/20; B60B 2900/521; B60B 2900/541; B60C 25/01

(57) ABSTRACT

A wheel rim includes a rim body including a central member and a peripheral well with a tire secured thereon wherein the central member includes an outboard tire bead seat is formed between an outer annular flange of the peripheral well and an inner annular ridge thereof, an inboard tire bead seat is formed between an inner annular flange of the peripheral well and an outer annular ridge thereof, an outboard tire bead of the tire is mounted on the outboard tire bead seat, an inboard tire bead of the tire is mounted on the inboard tire bead seat, and a diameter of the outer annular flange is less than that of the inn annular flange so that a replacement of the tire can be made by removing it through a peripheral opening; and a ring releasably secured to a peripheral edge of the rim body.

### BACKGROUND OF THE INVENTION

### 1. Field of the Invention

The invention relates to wheel rims and more particularly to a detachable rim for a vehicle wheel.

### 2. Description of Related Art

A vehicle tire is mounted on a rim which is an important component of an automobile. A conventional wheel rim includes a hub rotatably mounted on an axle, a plurality of spokes radially extending from the hub, and a rim member. The wheel rim has characteristics of being structurally strong, reliable in use and lightweight. Also, it addresses issues including being quick in assembly or disassembly.

For the conventional wheel rim, the rim member is secured to a tire and the tire is kept airtight. However, it is required that a mechanic, rather than an ordinary individual, uses a tool and/or a device to mount a tire on the wheel rim or detach the tire therefrom. In detail, in a tire replacement operation, a mechanic must deflate the tire, insert an elongated, flat rod into a joining portion of the tire and the rim member, exert force to slightly separate the tire and the rim member, and finally use a tire removal device to detach the tire from the rim member.

However, the above operation is both labor intensive and time consuming. Further, it can be done only by a mechanic rather than an ordinary individual.

Thus, the need for improvement still exists.

### SUMMARY OF THE INVENTION

It is therefore one object of the invention to provide a wheel rim in which only a tool (e.g., screwdriver) is required for the assembly of a tire or the detachment of the tire therefrom. Further, an individual, rather than a mechanic, can do it in an easy way.

It is another object of the invention to provide a wheel rim capable of quickly, easily mounting a tire thereon and keeping the tire in airtight thereafter.

For achieving above an other objects of the invention, there is provided a rim of a vehicle wheel, comprising a rim body including a central member and a peripheral well with a tire secured thereon wherein the central member includes an outboard tire bead seat is formed between an outer annular flange of the peripheral well and an inner annular ridge thereof, an inboard tire bead seat is formed between an inner annular flange of the peripheral well and an outer annular ridge of the peripheral well, an outboard tire bead of the tire is mounted on the outboard tire bead seat, an inboard tire bead of the tire is mounted on the inboard tire bead seat, and a diameter of the outer annular flange is less than that of the inn annular flange so that the tire is configured to replace with a new one by removing through a peripheral opening; and a ring releasably secured to a peripheral edge of the rim body to close the peripheral opening.

Preferably, the peripheral edge extends from an outer surface of the outer annular flange to an outer surface of the cavity, and wherein the peripheral edge is shaped complementarily to the ring so that the ring is configured to secure thereto.

Preferably, wherein the ring includes a plurality of holes equally spaced apart, the central member further comprises a plurality of equally spaced apart cavities on an annular edge, each cavity is formed with one of a plurality of threaded holes, and a plurality threaded fasteners are configured to drive through the holes into the threaded holes respectively, thereby securing the ring the peripheral edge of the rim body.

Preferably, the ring is shaped complementarily to the inner annular flange.

Preferably, the central member further comprises a hub and at least one spoke radially extending from the hub to an annular edge of the peripheral well.

### BRIEF DESCRIPTION OF THE DRAWINGS

The invention, as well as its many advantages, may be further understood by the following detailed description and drawings in which:

FIG. 1 is a perspective exploded view of a wheel rim according to the invention;

FIG. 2 is a perspective view of the wheel rim;

FIG. 3 is a longitudinal sectional view of the wheel rim;

FIG. 4 is a perspective exploded view of the wheel rim of FIG. 3 with a tire to be mounted thereon;

FIG. 5 is an enlarged view of the area in circle A of FIG. 4; and

FIG. 6 is a view similar to FIG. 4 showing the assembled wheel.

### DETAILED DESCRIPTION OF THE INVENTION

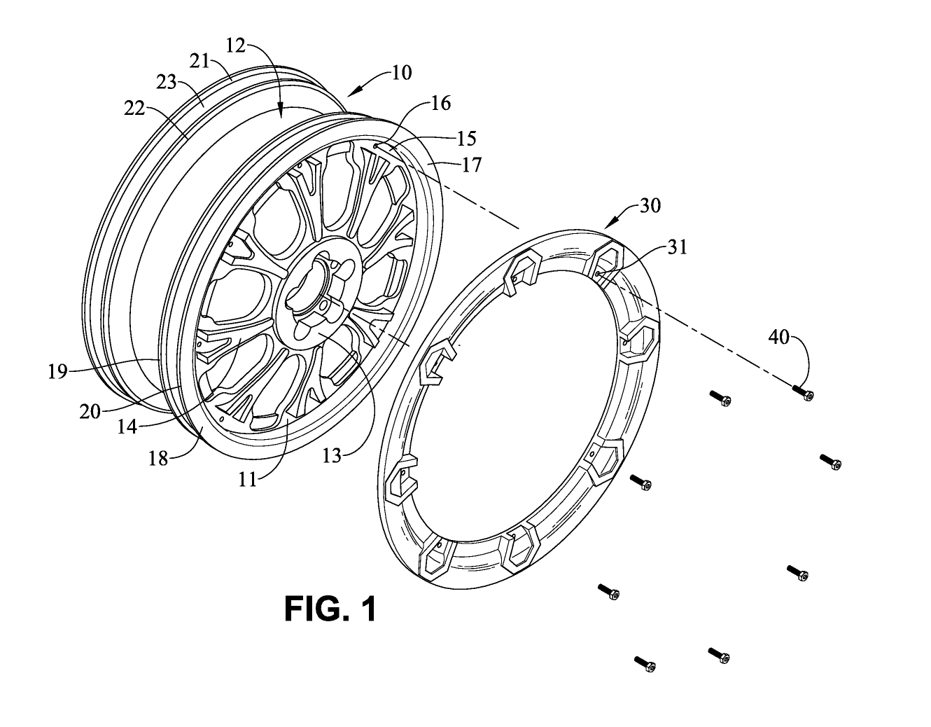

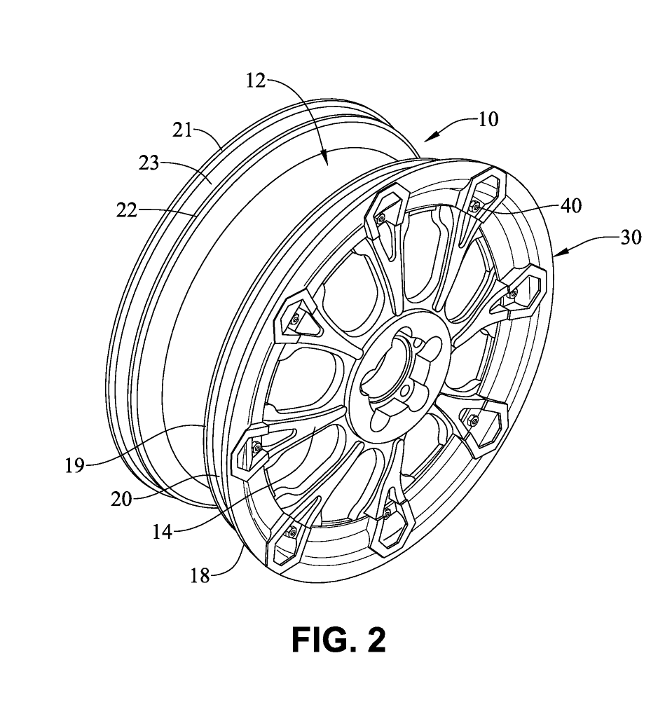

Referring to FIGS. 1 to 6, a wheel rim in accordance with the invention comprises a rim body 10 and a ring 30 as discussed in detail below.

The rim body 10 includes a central member 11 and a peripheral well 12 with tire 50 secured thereon. The central member 11 includes a hub 13 with an axle (not shown) of a vehicle fastened therein, and a plurality of spokes 14 radially extending from the hub 13 to an annular edge of the peripheral well 12.

The ring 30 includes a plurality of holes 31 equally spaced apart. A plurality of equally spaced apart cavities 15 are formed on an annular edge of the central member 11. A plurality of threaded holes 16 each are formed on the cavity 15. A plurality of screws 40 are driven through the holes 31 into the threaded holes 16 respectively. As a result, the ring 30 is secured to a peripheral edge 17 of the rim body 10.

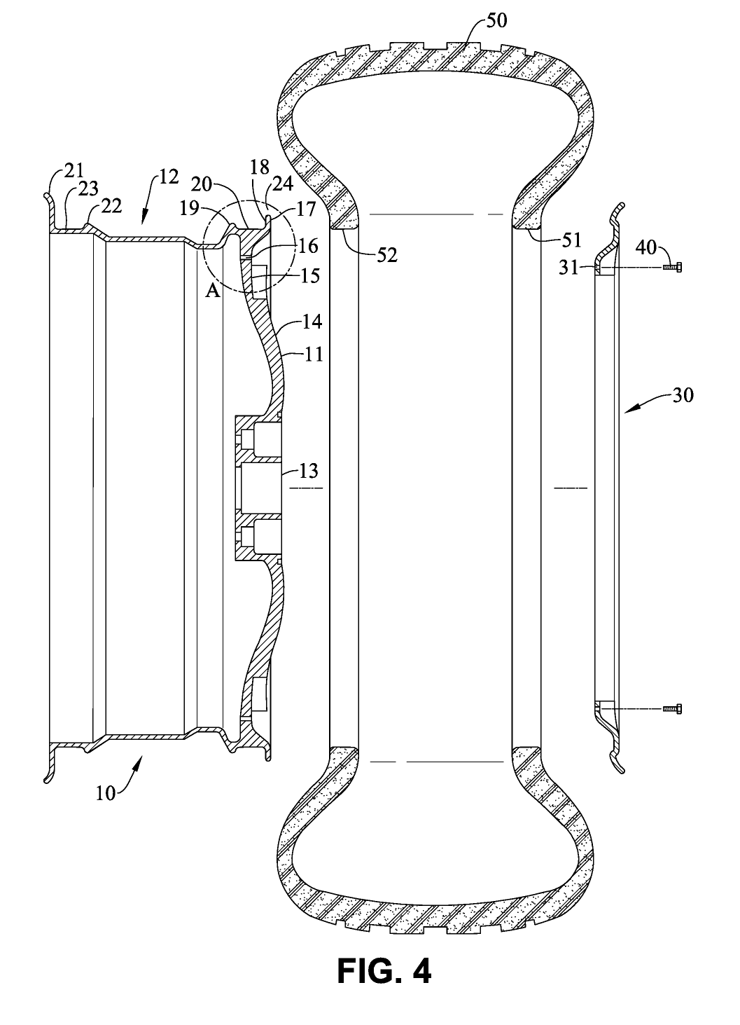

As shown in FIGS. 4 to 6 specifically, an outboard tire bead seat 20 is formed between an outer annular flange 18 of the peripheral well 12 and an inner annular ridge 19 of the peripheral well 12. An inboard tire bead seat 23 is formed between an inner annular flange 21 of the peripheral well 12 and an outer annular ridge 22 of the peripheral well 12. An outboard tire bead 51 of the tire 50 is mounted on the outboard tire bead seat 20 and an inboard tire bead 52 of the tire 50 is mounted on the inboard tire bead seat 23 respectively. It is noted that a diameter of the outer annular flange 18 is less than that of the inn annular flange 21 so that a replacement of a flat tire 50 can be made easy by removing through a peripheral opening 24.

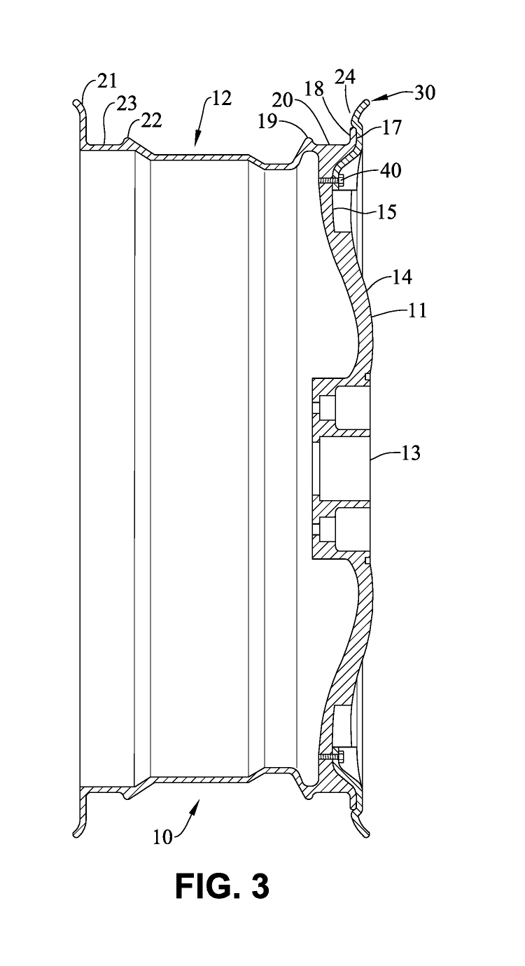

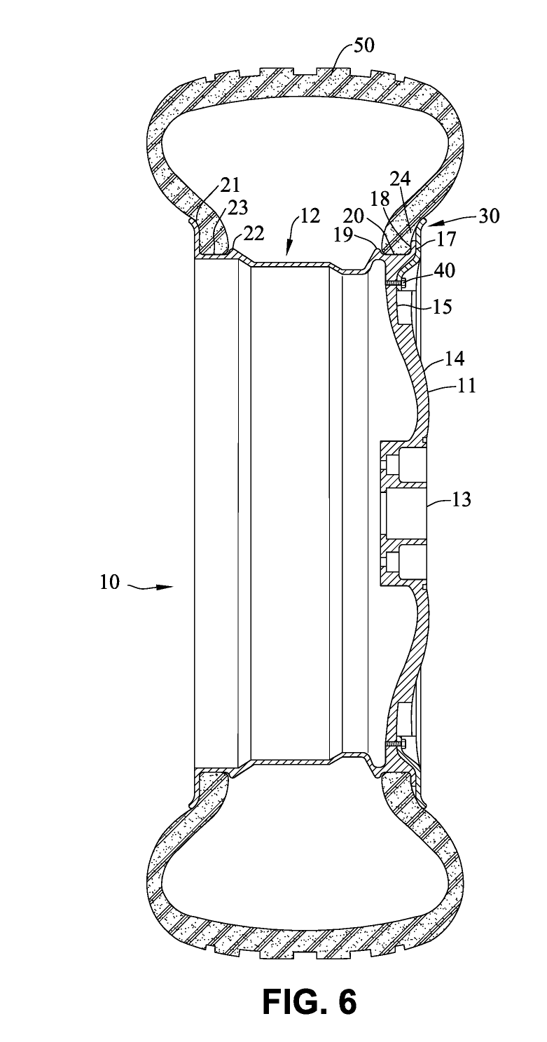

As shown in FIGS. 3 and 6 specifically, the opening 24 is closed when the ring 30 is releasably secured to the peripheral edge 17 of the rim body 10 by using the screws 40.

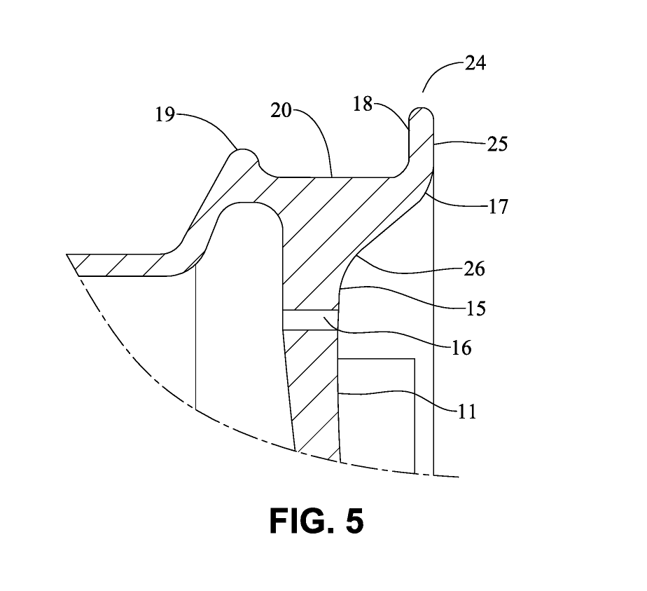

As shown in FIG. 5, the peripheral edge 17 extends from an outer surface 25 of the outer annular flange 18 to an outer surface 26 of the cavity 15. The peripheral edge 17 is shaped complementarily to the ring 30 so that the ring 30 can be successfully secured thereto.

As shown in FIG. 4 specifically, for detaching the tire 50, an individual may insert a needle (not shown) partially into a valve (not shown) of the tire 50 to release pressure of the tire 50. Next, the individual may rotate a screwdriver to unfasten the screws 40. As such, the ring 30 is detached with the opening 24 exposed. Next, the individual may slightly shake the tire 50 to detach the tire 50 from the ring body 10 by passing through the opening 24.

In a tire 50 mounting operation, the individual may perform reverse operations. In detail, the tire 50 is mounted on the rim body 10 by passing through the opening 24. Next, air is inflated into the tire 50 to urge both the outboard tire bead 51 of the tire 50 against the outboard tire bead seat 20 and the inboard tire bead 52 of the tire 50 against the inboard tire bead seat 23 respectively. As an end, the tire 50 is mounted. It is envisaged by the invention that only a tool (e.g., screwdriver) is required for the assembly or detachment of the tire 50. Further, an individual, rather than a mechanic, can do it in an easy way.

As shown in FIGS. 3 and 6 specifically, the ring 30 has a shape complementary to the inner annular flange 21. Thus, the mounted tire 50 is secured.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A rim of a vehicle wheel, comprising:
a rim body including a central member and a peripheral well with a tire secured thereon wherein the central member includes an outboard tire bead seat is formed between an outer annular flange of the peripheral well and an inner annular ridge thereof, an inboard tire bead seat is formed between an inner annular flange of the peripheral well and an outer annular ridge of the peripheral well, an outboard tire bead of the tire is mounted on the outboard tire bead seat, an inboard tire bead of the tire is mounted on the inboard tire bead seat, and a diameter of the outer annular flange is less than that of the inn annular flange so that the tire is configured to replace with a new one by removing through a peripheral opening; and
a ring releasably secured to a peripheral edge of the rim body to close the peripheral opening.

2. The wheel rim of claim 1, wherein the peripheral edge extends from an outer surface of the outer annular flange to an outer surface of the cavity, and wherein the peripheral edge is shaped complementarily to the ring so that the ring is configured to secure thereto.

3. The wheel rim of claim 2, wherein the ring includes a plurality of holes equally spaced apart, the central member further comprises a plurality of equally spaced apart cavities on an annular edge, each cavity is formed with one of a plurality of threaded holes, and a plurality threaded fasteners are configured to drive through the holes into the threaded holes respectively, thereby securing the ring the peripheral edge of the rim body.

4. The wheel rim of claim 1, wherein the ring is shaped complementarily to the inner annular flange.

5. The wheel rim of claim 1, wherein the central member further comprises a hub and at least one spoke radially extending from the hub to an annular edge of the peripheral well.
